(19) United States
(12) Patent Application Publication
(10) Pub. No.: US 2006/0015580 A1
(43) Pub. Date: Jan. 19, 2006

(54) Multimedia content distribution

(75) Inventors: Michael Gabriel, Greenwich, CT (US); Bruce Probst, Croton-On-Hudson, NY (US); Craig D. Cuttner, Norwalk, CT (US)

Correspondence Address: MENDELSOHN AND ASSOCIATES, P.C., 1500 JOHN F. KENNEDY BLVD., SUTIE 405, PHILADELPHIA, PA, 19102, US

(73) Assignee: Home Box Office, a Delaware corporation, New York, NY (US)

(21) Appl. No.: 11/052,313

(22) Filed: Feb. 7, 2005

Related U.S. Application Data
(60) Provisional application No. 60/585,160, filed on Jul. 1, 2004.

(51) Int. Cl. G06F 15/16

(52) U.S. Cl. 709/219; 709/246

(57) ABSTRACT

A process and facility supports device-specific delivery of a multimedia object to an end user's device as a function of the device's capabilities, the transport interface to the device, and/or the viewing state and/or access privileges of the device's user with respect to the object or the user's relationship to an owner of the device and/or multimedia object.

### CROSS-REFERENCE TO RELATED APPLICATIONS

This application claims the benefit of the filing date of U.S. provisional application Ser. No. 60/585,160, filed on Jul. 01, 2004.

### BACKGROUND OF THE INVENTION

1. Field of the Invention

The present invention relates to multimedia content distribution, and, more specifically, to the customization of characteristics of the transport mechanism, digital rights management, and/or format of multimedia content to suite content player capabilities, subject to the ownership relationships of those players.

2. Description of the Related Art

Multimedia content (e.g., video, audio, graphics, and animations) comes in various flavors (e.g., different combinations of presentation formats, compression formats, transport formats, and digital rights management (DRM) formats). Player devices, likewise, have a variety of different capabilities and limitations with respect to these various flavors of multimedia content.

### Digital audio formats and DRM

As an example, personal digital audio players (often referred to generically as “MP3-players” because of their support for the popular audio format for compressed digital audio known as “MP3”) from different manufacturers typically support different digital audio compression and DRM formats. For example, the “IPOD” personal digital audio player (manufactured by Apple Computer, Cupertino, Calif.) supports the MP3 and advanced audio coder (AAC) digital audio compression formats while the “Zen Micro” personal digital audio player (manufactured by Creative Labs, Inc, Milpitas, Calif.) supports the MP3 and windows media audio (WMA) digital audio compression formats (a product of Microsoft Corporation, Redmond, Wash.), but not AAC. Further, the IPOD, supports a type of DRM know as “Fairplay” that was developed by Apple Computer, while the Zen Micro supports a different type of DRM know as Microsoft Digital Rights Management (MS-DRM), that was developed by Microsoft Corporation. An IPOD player cannot play a song that was compressed using WMA and encrypted using MS-DRM; and likewise, a Zen Micro player cannot play a song that was compressed using AAC and encrypted using Fairplay. More information on MP3 and AAC can be found in International Standards Organization (ISO) and International Electrotechnical Committee (IEC) standards ISO/IEC 13318-3-2002 and ISO/IEC 14496-3-2004, respectively.

Video compression formats

As another example, a widely adopted format for video coding is standardized by ISO/IEC as “Information technology—Generic coding of moving pictures and associated audio information: Video,” ISO/IEC 13818-2-2002 (herein “MPEG-2 video” or “MPEG-2”), incorporated herein by reference in its entirety. MPEG-2 includes various profiles and levels, not all of which might be able to be decoded by a given decoder.

A profile is a defined subset of the syntax of the specification, and a level is a defined set of constraints on the values that may be taken by the parameters of the standard within a particular profile. MPEG-2 coded bitstreams contain a “profile_and_level_indication” parameter that specifies the simplest decoder that is capable of successfully decoding the bitstream. Typically, a decoder of a given capability can decode those bitstreams of a lower-level designation but not those of a higher-level designation. Thus, a main-profile at main-level (MP@ML) decoder may decode a standard-definition compressed video bitstream, but not a main-profile at high-level (MP@HL) bitstream (e.g., a high-definition bitstream). Video content encoded using MP@HL can deliver outstanding HDTV-quality video to a decoding device, but only a device that has sufficient memory (e.g., an MP@HL decoder) can properly render this video. On the other hand, if video content is delivered using an MP@ML bitstream, both MP@ML and MP@HL decoders can decode it, but in either case, the video quality will be limited to that of the MP@ML bitstream (e.g., standard definition).

An alternative format for video coding is also standardized by ISO, namely “Information technology—Coding of audio-visual objects—Part 2: Visual,” ISO/IEC 14496-2-2004 (herein “MPEG-4 visual” or “MPEG-4”), incorporated herein by reference in its entirety. MPEG-4 visual also defines profiles, including simple and advanced simple profiles. Like the MPEG-2 profiles, each of the MPEG-4 profiles is appropriate for a decoding device with a given set of capabilities.

MPEG-2, MPEG-4, and other multimedia encoding formats typically also include support for scalability. For example, video scalability offers a set of tools by which video can be coded at different resolutions (e.g., different scales) in a single bitstream. On the decoder side, video can be decoded at a suitable resolution by extracting the portion of the bitstream that represents a particular resolution. Among other advantages, scalability adds compatibility with devices of different capability but usually at the cost of some bitstream overhead.

Format Selection/Restrictions

Present day cable and satellite service providers typically encode some of the programs they distribute in at least standard-definition (SD) and high-definition (HD) video formats. Subscribers of these services are typically provided with equipment that can decode one or more of these formats. The equipment typically provides the subscriber with a means for selecting between supported formats but lacks certain intelligences associated with the user interaction with the content.

For example, a cable service provider may provide two pay-per-view movies, one in SD format, and the other in HD formats, with the HD movie typically offered at a price premium over the SD movie. A subscriber to one of these services is typically provided with a digital set-top box equipped with a program guide that the subscriber can use to select between the movies. If the subscriber has an HD digital set-top capable of decoding both HD and SD video content, then he can choose either movie, his choice potentially predicated upon the difference in cost between the two movies or his preference for one movie over the other. However, if the subscriber has only an SD digital set-top capable of decoding only standard-definition digital video content, the subscriber cannot watch the HD movie.

Similarly, assume a subscriber has both HD and SD digital set-tops, the first in the living room and the second in the bedroom. If he purchases the HD movie and starts to view it on the HD set-top in the living room but wants to finish viewing the movie in the bedroom, he would be prevented from doing so because the SD set-top in the bedroom would be unable to decode the HD movie. If an SD version of the movie were available, he might then choose to purchase the SD version of the movie and fast-forward the movie (if this feature were available) to the place where he left off in the HD movie, but then he would typically be billed for both versions.

Consider further the same subscriber with two HD digital set-tops, one in the living room and one in the bedroom, but where the one in the living room is connected to an HD display and the one in the bedroom is connected to a display with only SD capability. In this case, assuming the HD digital set-top in the bedroom can down-convert the HD version of the movie to SD before outputting the decoded output to the SD display, the subscriber might be able to purchase the movie and watch the first half in the living room in full HD resolution and still watch the second half of the movie in the bedroom, albeit at a reduced resolution. However, assuming he did not have to purchase yet another copy of the movie for the second HD set-top in the bedroom, he would still be billed for the HD version of the movie, while he watched only half of it in HD, because the second set-top had no knowledge of the fact that the movie asset was purchased by the first set-top, nor was there any system in place that could correct the billing following the change.

Finally, consider the same subscriber, who, in addition to the two HD set-tops, also has a computer-based home-theatre system (PCTV) in his den, where the PCTV is equipped with an MPEG-4 visual decoder and a broadband Internet connection. In addition to his cable service, the subscriber may also have access to an online movie service that provides movies for streaming over the Internet in MPEG-4 visual format. If the user were to want to watch some portion of the movie on his den computer system, he would have to first purchase it from the online movie service provider. He would now have potentially purchased three versions of the movie, simply for the convenience of watching the movie on his preferred playback device.

In all of the aforementioned situations, to avoid unnecessary cost or complications, the subscriber should know on what playback device he intends to completely view his multimedia content and, to some extent, the format capabilities and peripheral connections of his device. As the number of options related to multimedia formats, device types, and interfaces continues to expand, burdening the subscriber with the details of these options is becoming increasingly more undesirable.

Multiple Networks

Infotainment devices (e.g., wireless PDAs, portable video viewers, video conferencing-capable cell phones, automobile-theatre systems, and home-theatre systems) continue to proliferate. Similarly, the network protocols that support these devices continue to expand. Traditional video delivery networks including terrestrial analog and digital broadcast, cable, and direct-to-home (DTH) satellite that typically service relatively fixed playback devices (e.g., digital cable set-top boxes) are now competing against new delivery networks for mobile multimedia devices that include 3G wireless cellular networks, home area networks (e.g., IEEE 802.1 lb/g) and broadband internet protocol (IP)-based delivery networks (e.g., integrated services digital network (ISDN), digital cable modem, satellite, and IEEE 802.16). Multimedia delivery to automobiles via satellite is now commercially available using phased-array antenna systems such as those provided by KVH Industries of Middletown, R.I., USA and OFDM systems such as those provided by XM Satellite Radio of Washington, D.C. In all these areas, the diversity of protocols and interfaces to these devices continues to expand.

As an example of the problem, consider the subscriber of the previous example who purchases a movie from his cable company to watch on his SD digital set-top. This movie is typically stored in a video server at a cable plant's headend and transported to the subscriber via a hybrid-fiber-coax (HFC) network. In such a network, SD video is segmented into MPEG-2 transport packets and then modulated using 64 or 256 QAM onto the physical connection between the headend and the subscriber's home. Assume the subscriber needs to leave the house but he wants to continue watching the movie on his mobile video player that uses 3G wireless technologies to receive streamed video. To watch the movie, it would have to be (at a minimum) repackaged in a transport (e.g., Internet Protocol/CDMA2000) that was compatible with the 3G network for his video player. It is also likely that the compression format decoding capabilities of the user devices would be incompatible (e.g., MPEG-2 vs. MPEG-4) between the networks.

Digital Rights Management

Also presently, there are various methods and devices that support the restriction of the playback of given content to only those devices that are specifically authorized to play back the given content. Such DRM systems can, for example, encrypt a stream of digitally encoded content with a specific encryption-key such that the content can be decrypted only by devices that share or can derive that encryption key or one of a group of related decryption-keys that will allow the content to be decrypted.

Present-day cable and satellite systems utilize DRM to prevent users from viewing content that they are not authorized to view. For example, a premium service (e.g., HBO) is typically encrypted before it reaches a customer. When a customer subscribes to the premium service, an authorization is sent to the customer's set-top box or boxes, where the authorization contains a code that the set-top box(es) can use to derive a key that can be used to decrypt the premium content, thus allowing it to be decoded for display and viewing.

This encryption is typically specific to a particular service provider and playback device. So, for example, if a cable subscriber purchased a movie on his set-top, he would not typically be authorized to view this movie on any other device.

### SUMMARY OF THE INVENTION

Problems in the prior art are addressed in accordance with principles of the present invention by a process and multimedia content distribution facility (MCDF) that supports device-specific delivery of multimedia content to a user's playback device as a function of the playback device's capabilities, the transport interface to the device, and/or the viewing state and access privileges of the user with respect to the multimedia content.

In one embodiment, the invention includes a multimedia-object server (e.g., MPEG-2 video/audio server), a user-profile database, and an application server operatively coupled to one or more networks (e.g., broadband MPEG-2 transport networks and/or broadband IP networks). The multimedia-object server contains copies of a multimedia object (e.g., a movie) in two or more formats and/or the ability to transcode the multimedia object from a stored format to at least one other format. The user-profile database contains information regarding a user including: access privileges of the user relative to various multimedia objects, devices associated with the user, and, for each device associated with the user, format requirements of the device. Upon receiving a request to view content from a user's device (the request, in this embodiment, including at least an identifier for the device), the application server interacts with the user-profile database to determine (1) the owner of the device, and (2) the device's rights to access the requested content as a function of the owner's viewing rights with respect to the content. The format requirements of the device can be stored in the user profile database, a separate device database, or be supplied by the device along with its request to view the media object. The application server then interacts with the multimedia-object server to accomplish streaming of an appropriate format of the media object to the device for viewing.

Additionally or alternatively, in one or more embodiments, the network and transport requirements of the requesting device are determined by lookup in the user-profile database, sent along with the viewing request, or determined by the application server via the port or interface from which it received the viewing request.

Additionally or alternatively, in one or more embodiments, to protect the rights of the multimedia content providers, the viewing request includes authentication data that is used by the application server or an associated authentication server (e.g., RADIUS server) to determine whether a requesting device is actually the device it has identified itself to be. If it is, then an encryption mode and/or key associated with the playback device is either passed (in this case, securely) from the device to an encrypting element attached to the video server. This key and/or mode can alternatively be accessed (securely) from the user-profile database, or a key server. The content is then encrypted using this key and/or mode and sent to the playback device for decryption, decoding, and viewing.

Additionally or alternatively, in one or more embodiments, the user-profile database stores the viewing state of each multimedia object purchased by a particular device's user/owner. When the application server receives a viewing request from a playback device, the device's identifier is used to identify the device's user/owner and the viewing state of the requested object with respect to that user/owner. The viewing state includes, for example, the reference timecode relative to the beginning of the multimedia object that specifies the point at which, for example, the multimedia object was paused during a prior viewing. This pause point can be then be passed to the multimedia-object server so that the video server can index into the multimedia object and resume the streaming from the point where the prior viewing was paused.

### BRIEF DESCRIPTION OF THE DRAWINGS

Other aspects, features, and advantages of the present invention will become more fully apparent from the following detailed description, the appended claims, and the accompanying drawings in which:

FIG. 1 depicts exemplary multimedia content distribution facility (MCDF) 100 and related equipment according to the present invention.

FIG. 2 depicts exemplary application server process 200 according to the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

Exemplary multimedia content distribution facility

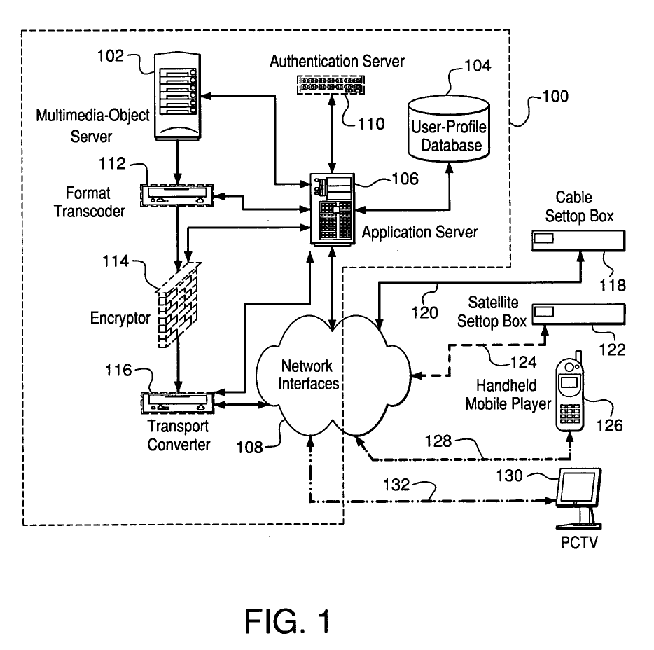

FIG. 1 illustrates exemplary multimedia content distribution facility (MCDF) 100 and related equipment according to the present invention. MCDF 100 includes multimedia object server 102, user-profile database 104, application server 106, and network interfaces cloud 108. MCDF 100 optionally includes authentication server 110, format transcoder 112, encryptor 114, and transport converter 116. The invention is shown in the context of a subset of potential playback devices and their commonly associated networks. These include cable set-top box 118 and HFC network 120, satellite set-top box 122 and direct-to-home QPSK link 124, handheld mobile player 126 and cellular network 128, and personal-computer-based television (PCTV) 130 and IP/broadband pipe 132.

Multimedia-object server 102 stores multimedia content (e.g., movies or books on tape), potentially in more than one format (e.g., MPEG-2 and/or MPEG-4 for movies and MP3 and/or WMA for books on tape). User-profile database 104 stores fully relational, user-profile data that includes records for a plurality of users, multimedia objects, and devices. Application server 106 serves as an intermediary (making use of data stored in the user-profile database) between (1) user requests for viewing of content on various playback devices and (2) multimedia-object server 102, which stores the multimedia content. Finally, network interfaces cloud 108 provides for communication (sometimes involving protocol conversion) between the playback devices and the application server.

User-profile database

As mentioned above, user-profile database 104 stores user-profile data that includes records for a plurality of users, multimedia objects, and devices.

Each user record includes, for example, billing address information for the user, billing method (e.g., credit card) used, multimedia objects purchased (i.e., owned) by the user, devices owned by the user, and parent-, child-, and group-ownership relationships that affect access privileges (with respect to objects) and parental control (with respect to devices) for the user. Note that some elements of a user record can be redundant to, synchronized with, copied from/to, or derived from elements of a billing server (not illustrated in this embodiment) as is understood to one skilled in the art.

Each multimedia object record includes, for example, a descriptor for the multimedia object, which object could be, for example, a subscription to a premium cable channel (e.g., HBO) or a copy of a movie. Each multimedia object record also typically includes the format of the object (e.g. MPEG-2 or MPEG-4), as well as access privileges (e.g., view once, view N times, view always, and copy once/M times/never), access state (e.g., viewed P times and/or copied Q times), and viewing state (e.g., where, in a previously, partially viewed movie, the owner paused his viewing) of the object with respect to the user of the object. Some clarification of the difference between a user and an owner is provided in the section titled “Authentication example” below.

Each device record includes, for example, a descriptor for the device, a device-type indicator, format capabilities of the device, software/firmware versions loaded on the device, encryption keys for the device, transport- and network-layer protocol requirements of the device, and ownership information for the device. Device records can also include parental-control information with respect to the devices (e.g., what ratings, genres, or specific objects may be viewed).

An initial and/or on-going registration process (described later) populates the user-profile database. It is assumed that user-profile database 104 is populated with data of the above nature at some point before the steady-state operation ensues, and that data is purged and deleted on an ongoing basis, as would be understood to one skilled in the art.

Format selection example

As an example of the operation of the invention, assume that a user of, for example, HD cable set-top device 118, makes a request over cable HFC plant 120, to play a movie. The request is received at network interfaces cloud 108 where is it converted (if necessary) to a protocol that application server 106 can understand. Application server 106 receives the request, which includes a device identifier (ID) for the cable set-top box, and a movie ID. The application server uses the device ID in a query to user-profile database 104. Assuming device 118 has previously been registered with the system, the query will yield the device format requirements (e.g., MPEG-2 MP@HL) and the device's ownership information.

Using the movie ID and assumed user information (in this example, the user is assumed to be the owner of the device), application server 106 then queries user-profile database 104 to see if the movie had previously been purchased by this user, and if so, if viewing had previously been started and then paused. If this is the case, database 104 will then yield a timecode offset into the movie that represents the viewing state of the movie. Other viewing-state data or stored user preferences (e.g., closed caption ON and language selection) can also be supplied at this time. The application server then forwards the movie ID, viewing state, preferences, and device format capabilities to multimedia-object server 102. Assuming the server contains a copy of the movie in HD format, the server indexes into the movie and starts to stream the movie to the cable set-top in the HD format. If the user again pauses the movie at this or a later point, then multimedia-object server 102 reports the viewing state of the movie back to the application server, which then stores the updated viewing state of the movie in the user-profile database.

Note that, if an HD format copy of the movie were not available, but an SD format copy was available, then the server could have chosen to stream the SD format copy to the set-top since SD is a format that is almost always supported by an HD set-top.

Now assume that the user leaves home, taking with him handheld mobile player 126. If the user wishes to continue the movie he was watching on his set-top, he can now turn on handheld mobile player 126 and request the movie over wireless network 128 to application server 106 via network interfaces cloud 108. The request is protocol-converted (as necessary by the network interfaces cloud) before reaching the application server. The request again includes at least a device ID and a movie ID. The new device ID is used in a query to the database that yields the format capabilities of the handheld player and the owner of the device, and hence the movie access rights of the movie with respect to the user, as well as the viewing state of the movie with respect to the user. Assuming the user is requesting to watch the same movie that he was watching on his set-top box, the viewing state would indicate where he left off previously and this viewing state, the movie ID, and the format capabilities of the device (e.g., MPEG-4) would be communicated by the application server to multimedia-object server 102. The server, assuming it has a copy of the movie in MPEG-4 (e.g., simple profile), will then index into the movie and start streaming it to handheld mobile player 126 via network interfaces cloud 108 and wireless network 128, and the user would be able to continue watching his movie from where he left off, the complexities of the transactions involved being handled primarily by MCDF 100.

Format transcoding example

In one embodiment of the invention, MCDF 100 includes format transcoder 112, capable of taking a multimedia object in one format and transcoding it to another format under control of application server 106. In the above example, if the multimedia-object server did not have a copy of the movie in the requested format, then, in this embodiment of the invention, the transcoder receives the movie in a first format (e.g., MPEG-2 format) from multimedia-object server 102 and transcodes it to the required format (e.g., MPEG-4 simple profile) before streaming it to the handheld mobile player. Transcoders, such as the FlipFactory by Telestream of Nevada City, Calif., are understood in the art and more detail can be found by referring to the literature surrounding those devices.

Authentication example

In various embodiments of the invention, MCDF 100 includes authentication server 110. In many applications, it may be of interest to determine that a request for playback actually originated from a particular device (or user—see below). In such an embodiment, a request for service (e.g., a movie) can include an authentication code that is passed by the application server to the authentication server before further action is taken. The authentication code typically includes a signature for the device, which signature can have been encoded only by the device. A public key associated with the device can either be stored in the authentication server or stored in the user-profile database and passed to the authentication server by the application server for use in authenticating the device. Once authenticated, the request can be processed as discussed previously.

In one of the earlier examples, it was assumed that the user of a device was the owner of the device and therefore the device user was granted the same permissions and profile/state/preferences as the device's owner. However, a device user is not always the device owner. Said another way, in various embodiments of the present invention, a multimedia-object owner is not restricted to only accessing that multimedia-object through devices that he specifically owns. For example, an owner of a multimedia object may wish to access that object from a public video kiosk in an airport or using a friend's handheld mobile player. To support this option, various embodiments of the present invention support user authentication in addition to or instead of device authentication. Such user authentication can be accomplished via password verification or, for example, via fingerprint or voice authentication techniques.

Authentication procedures are understood in the art. More information can be found in, for example, Handbook of Applied Cryptography, A. J. Menezes, CRC Press, New York, 1996 (herein “Menezes '96”), chapter 10, “Identification and Entity Authentication,” pp. 385-424, incorporated herein by reference in its entirety.

Encraption example

To take advantage of legal remedies to copyright infringement that have recently been made available to copyright owners as a result of the Digital Millennium Copyright Act (DMCA), it is of interest to protect multimedia content using encryption technology. To support this, in various embodiments of the present invention, MCDF 100 includes encryptor 114. In these embodiments, for example, user-profile database 104 can store encryption keys associated with each device, the keys being passed by application server 106 to encryptor 114 for the purpose of encrypting the requested multimedia content for a requesting device before it is streamed to the device. Note that other approaches are also possible, including encrypting the content once and storing it on the multimedia-object server in encrypted format. In this case, a device requesting a multimedia object can be authorized to decrypt the object based on, for example, keys that are securely embedded or delivered to the device. These various options would be understood to one skilled in the art to fall within the scope and intent of the present invention. Various streaming multimedia encryption and pre-encryption architectures are discussed in more detail in, for example, U.S. Pat. No. 6,681,326, “Secure distribution of video on-demand,” filed May 7, 2001, incorporated herein by reference in its entirety. Encryption techniques including key management procedures are understood in the art. More information can be found in, for example, Menezes '96, chapters 12, 13, and 15, each chapter incorporated herein by reference in its entirety.

Transport conversion example

Depending on the network that multimedia content is being streamed to, modification of the transport and protocols of the multimedia content can be useful. For this reason, various embodiments of MCDF 100 include transport converter 116, which can translate between various network protocols, encapsulations, and interfaces as required. As an example, on cable plants, MPEG-2 video is carried in MPEG-2 transport packets of 188 bytes. Forward error correction and other overhead bits are added to the stream, and the stream is then modulated in 64 or 256 QAM before being transmitted over cable. However, when MPEG-2 is carried on a data network, the MPEG-2 transport packets can be encapsulated directly within Internet protocol (IP) packets. On ATM networks, on the other hand, MPEG-2 transport packets are encapsulated in ATM packets according to the rules of ATM adaptation layer 5 (AAL5). MPEG-4 can be carried in MPEG-2 transport, or directly in IP, if so desired, and either of these protocols can be further carried in real-time protocol (RTP). Such procedures are understood in the art. More information can be found, for example, in: ISO/IEC 13818-6:1998 “Information technology—Generic coding of moving pictures and associated audio information”—Part 6: Extensions for DSM-CC; C. Tryfonas, “MPEG-2 TRANSPORT OVER ATM NETWORKS,” IEEE Communications Surveys, http://www.comsoc.org/pubs/surveys, Fourth Quarter 1999, vol. 2 no. 4; and publications of the IETF working group on Audio/Video Transport (AVT)—extensions to real-time protocol (RTP) including RFC 1899 and RFC 1890, each document incorporated herein by reference in its entirety.

Presentation and navigation example

Note that there is not always a clear division between network interfaces, transport encoding, and content encapsulation. For example, for proper presentation of video on playback devices, it is sometimes useful to wrap the video in various indexing and descriptive formats. Set-top application and presentation layers of set-top middleware often are designed to expect or utilize the additional wrapper information to provide enhanced presentation of the data, or navigation capabilities within the data, on the playback device. In one or more embodiments of MCDF 100, the specifics of such multimedia content preparation specific to a device is managed in one or more of multimedia-object server 102, format transcoder 112, encryptor 114, transport converter 116, or network interfaces cloud 108. The details of such wrappers and tag extensions to multimedia content are known in the art. Possible formats include, without limitation, Windows Media or audio-video interleave (AVI) (both products of Microsoft, Redmond Wash.), Real Media (a product of Real Networks, Seattle, Wash.), QuickTime (a product of Apple Computer, Cupertino, Calif.), DV, MPEG-1, MPEG-2, MP3, WAV, DVD, MPEG-4 visual, MPEG-4 AVC, MPEG-7, synchronized multimedia integration language (SMIL), extensible markup language (XML), and OpenCable (an initiative of CableLabs, Louisville, Colo.) applications platform (OCAP).

Alternatives

The present invention may be implemented in various ways. The elements of the embodiment of FIG. 1, for example, can be grouped in many different ways depending on implementation choices of a manufacturer. For example, the format transcoder and encryptor can be integrated into the multimedia-object server. Alternatively, the authentication server and encryptor can be housed together, or be part of a billing server. Each of the elements as well as the entire system can be implemented in distributed or centralized fashion. Multimedia-object server clusters can be used in place of a single multimedia-object server. Additionally, alternative methods to those described in the embodiment of FIG. 1 can be used. For example, rather than storing device capabilities in the user profile database, these capabilities can be carried in a request from the device to the application server. Alternatively, device capabilities can be assessed via inference from the transport interface (e.g., a device that is requesting via a cable headend infrastructure in the United States can be assumed to be compatible with MPEG-2 video carried in MPEG-2 transport over 64/256QAM as described by relevant SCTE standards). Similarly, protocol interfaces can be determined by query, negotiation, and trial and error procedures as is understood in the art.

Options and features

Various embodiments of the present invention can include one or more of the following elements or features:
1. A multimedia-object server that includes a single or cluster of video/audio servers with videos/audio content stored in the file system in a variety of encoding formats including AAC, MP3, MPEG_{—}2, MPEG-4, H.264, and/or Windows Media 9. Each file can contain a unique identifier and/or be part of, or associated with, an XML metadata file. The video/audio can be requested over DSL, cable, satellite, 3G wireless, or other broadband media using a variety of protocols including UDP/IP, TCP/IP, and RTP, and modulations including QAM, QPSK, spread spectrum, TDMA, CDMA, PCS, and GSM.
2. A user-profile database, either separate from or in conjunction with a billing system (e.g., a cable billing system or telephone billing system), that supports keeping track of a user's profile detailing the user's preferred or applicable means of receiving content (e.g., format, digital rights management (DRM) characteristics, and transport). The user-profile database stores consumer billing keys, information on viable locations for viewing of multimedia content and/or applicable mobile devices and the protocols used to access those devices. It can include set-top box unique keys, IP addresses, domain names, and other data associated with a user.
3. A registration session with the application server, during which a user can set up account names, passwords, and a list of devices that he owns as well as their characteristics. A method to associate a user name with a unique set-top box identifier can take place through an existing billing system within the cable system or it can be accommodated using the application server in conjunction with the user-profile database. The user can create sub-accounts and set ratings, time, and amount of download limits, etc., per each account. Each sub-account can have its own set of devices, each with its unique transport and format capabilities.
4. A requesting program or device providing information that an application server can use to determine:

a. Optionally, a user-identifier key.

b. The type of the device, relevant protocols, and formats supported.
5. An application server adapted to transmit an SMIL-enabled wrapper around the video/audio, the wrapper used to facilitate start, stop, pause, rewind, etc., of a multimedia object on an appropriate SMIL-compliant player. SMIL is an application presentation protocol that works on websites, mobile multimedia devices, and set-top boxes. Similar to the OpenCable Applications Platform (OCAP) but more generic, SMIL is a markup language designed to present multiple media files together. For instance, instead of streaming video with an integrated soundtrack, separate video and audio files can be streamed and synchronized via SMIL. This allows users to choose different combinations of multimedia objects (e.g., to get a different language sound track) and permits text transcripts to be optionally selected and presented, providing enhanced accessibility (e.g., to hearing impaired viewers). OCAP is a middleware software specification that enables developers of interactive television services and applications to design products to run successfully on any cable television system in North America that supports the OCAP standard, independent of set-top or television receiver hardware or operating system software choices. Its first version, OCAP 1.0, was issued in December 2001 by CableLabs of Louisville, Colo. OCAP 1.0 defines a Java-based execution engine. OCAP 2.0, released by CableLabs in April of 2002, extends the standard to include a presentation engine that includes web-based technologies, like XHTML, XML, and ECMAScript. Each of these specifications is incorporated herein by reference in its entirety. OCAP 1.0 is designed to allow applications like electronic program guides or interactive transactions to execute inside set-top boxes, and have their outputs be displayed on TV screens. OCAP 2.0 enables web browsers and associated web-based applications to display HTML-based content to a user. This opens the door for users of player devices to access a wealth of information that is stored on the Internet. The OCAP specification is largely based on the European “Multimedia Home Platform” (MHP) middleware specification created by the Digital Video Broadcasting (DVB) organization, and also incorporated herein by reference in its entirety.
6. The application server can control packaging multimedia objects provided by the multimedia-object server into a wrapper or interface appropriate for each specific requesting set-top box, as a function of the set-top type, software/firmware revisions, memory characteristics of the set-top, and/or preferences or characteristics of the user as stored in the user-profile database or interactively determined via a two-way dialog with the user. If the set-top box contains an OCAP-enabled operating system, then the local application can request, by a unique identifier, the asset to be sent to the set-top. If the requesting program is running on a mobile device (e.g., a phone or a handheld video/audio player), then a similar process would ensue.
7. The user can be identified with a unique identifier from the requesting device (e.g., a phone number, MAC address, or CPU serial number). The content can then be transmitted to the device using an encryption method or a DRM wrapper that would require a license to be passed to ensure asset security. A similar approach can be applied to a PC requesting a video/audio asset. Some of these methods presuppose that a consumer has set up a profile defining account names, passwords, and devices. Alternatively, various embodiments of the present invention include an on-the-fly and/or incremental registration process that allows registration as a function of an initial multimedia content purchase via any device.
8. The service provided by the invention can be essentially format agnostic. The server stores a variety of formats or a subset of formats can be transcoded as required.
9. The service can enforce the rule of “buy it once” for multimedia objects. It allows the playback of a purchased multimedia object independent of the device. It supports global knowledge of multimedia object ownership across all of a user's known devices.
10. A user can be a single individual, a family group, friends and family, a corporate group, a club relationship, or an ad-hoc association of consumers.
11. Multimedia objects accessible on a particular device can be presented by a unified user interface such as that described in co-pending application, Ser. No. 10/753,860, filed on Jan. 7, 2004, entitled “Integrated Media Viewing Environment,” incorporated herein by reference in its entirety.
12. The invention can support a common, seamless interface for a user (a single subscribing entity) across multiple devices that he owns. These devices are considered part of a single trusted domain.
13. In various embodiment of the present invention, device-to-user associations can be drawn from a billing system on-the-fly or via automated registration.
14. If a user is watching a movie at home on his set-top and then leaves his home, in certain embodiments of the present invention, the user can pick up his mobile viewing device, press play, and automatically resume the movie from where he left off. The MCDF would manage the details of using a new transport and a new format, as required, to deliver the rest of the movie, recognizing the association between the mobile viewing device, the set-top, and the user.
15. Certain embodiments of the present invention support a user attempting to access his purchased multimedia assets via a third-party or public playback device such as a kiosk. Such embodiments can be supported by various means including a unique login through the kiosk, where a user's unique id is passed through the kiosk to the application server and from there passed to an authentication server. A positive authentication is then used to allow the kiosk to be considered part of the user's group of authorized playback devices.
16. Certain embodiments of the present invention support the ability to move subscription around between devices, as long as the devices belong to the user's profile or are registered.
17. Certain embodiments support the concept that purchase of viewing rights is a one-time event, and ownership and viewing rights should persist and be enabled across a heterogeneous group, potentially, of playback devices. In these embodiments, the access rights remain the same, independent of the specific capabilities of the device, whether the type of the device is a home entertainment system, a car entertainment system, a mobile hand-held infotainment device, or some other type of playback device.
18. The invention can incorporate parental control on the basis of location/device/time-of-day.
19. One embodiment of the invention is a system and method for conveying the same content in one or more derivative formats to a group of related devices, wherein the relationship is an association to a single user, single family, or single corporate structure or groups thereof.
20. In one embodiment, the invention features the ability to authenticate a user via any of the user's devices and allow delivery of content to the same or another of the user's devices. The embodiment thus supports linking authentication based on family plan, family share plan, corporate users groups, or other ad hoc groups.

The content streams as described herein may be in digital or analog form.

Application serving process

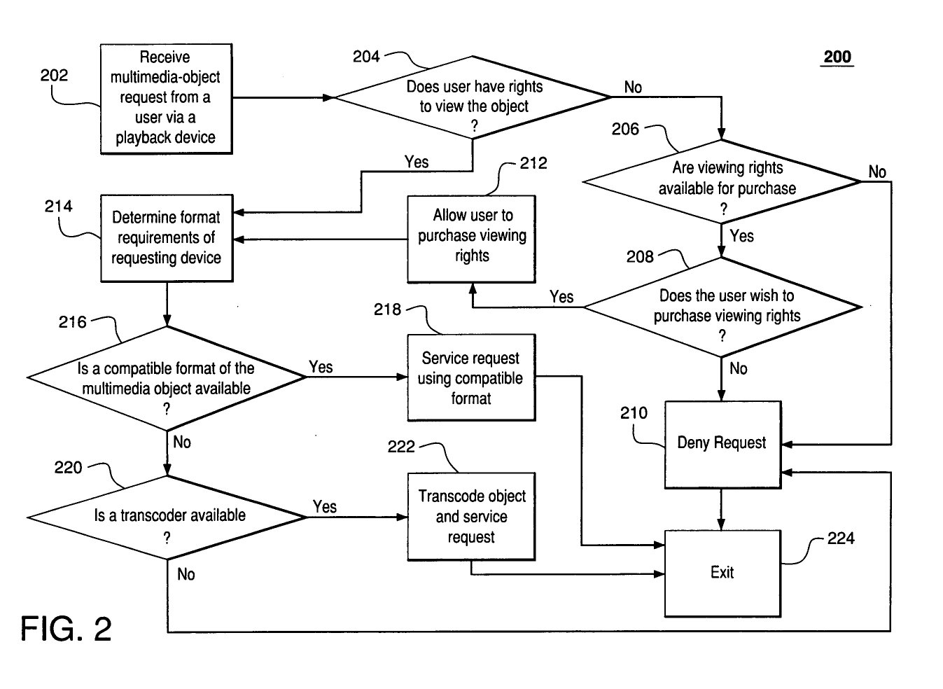

FIG. 2 depicts exemplary application server process 200 according to the present invention. In step 202, a multimedia-object viewing request is received from a user via a playback device. In step 204, a test is performed to see if the user has rights to view the object. This test can involve a query to a viewing-rights portion of a user-profile database, where a unique user identifier and a unique object identifier are passed to the database as search criteria, or alternatively, this test can involve authentication of permission (e.g., a coupon or secure token) that is passed from the user to the process as part of the viewing request. Alternatively, the test can involve a combination of these mechanisms. Note that the identify of the user can be inferred from a device identifier, or alternatively, can be determined via, for example, a user name and password dialog with the user. If, in step 204, it is found that the user does not have viewing rights, then in step 206, a test is performed to see if viewing rights are available for purchase. It may be that a copy of the object does not exist in the system and therefore viewing rights are unavailable for purchase for that reason. Or it could be that some limit on the number of viewings (i.e., “copies” in a computer system context) has been reached. In any event, if no viewing rights are available, then, in step 210, the request is denied and the process concludes in step 224. If, however, in step 206, it is determined that viewing rights are available for the object, then in step 208 a dialog is held with the user to determine whether he wishes to purchase those rights. If he does not, then in step 210, the request is denied and the process concludes in step 224. If, however, in step 208, it is determined that the user does wish to purchase viewing rights, then in step 212, a purchase dialog is executed with the user (e.g., prompt for credit card) allowing the user to purchase the rights. In either this case, or if in the test of step 204 it was determined that the user has rights to view the object, the process continues with step 214, where the format requirements of the device are determined. Next, in step 216, a test is performed to see if, among the stored versions of the multimedia object, a format is available that is compatible with the device. If an appropriately formatted version of the object is available, then in step 218, the request is serviced (e.g., the object is streamed to the device) and the process concludes in step 224. If, however, in the test of step 216, it is determined that no compatible format is available, then in step 220 a test is performed to see if any format transcoders are available. For example, if the device supports only MPEG-2 SD video and only an MPEG-2 HD video stream is available, then an MPEG-2 HD-to-SD transcoder is needed. It may be the case that no such transcoders are included in a particular system's implementation. Alternatively, it maybe the case that there are some such transcoders in the system, but they are all in use by other contemporaneous transcoding operations. In either event, if no transcoders are available, then in step 210 the viewing request is denied and in step 224, the process concludes. If there is a transcoder available, however, then in step 222, the object is transcoded (e.g., in real time) and streamed to the device in fulfillment of the viewing request. Upon completion of the streaming, the transcoder is released and the process concludes in step 224.

In this specification, the scope of “multimedia objects” is intended to include such things as applications, executable scripts, and 3D graphical and interactive structures including avatars, games, and graphical tools. “Viewing rights,” as used herein, implies not only the traditional viewing as understood in the context of a visual or aural object, but additionally viewing is defined to include actions such as execution, manipulation, interaction, mixing, derivation, copying, and sharing, depending on context, as would be understood to one skilled in the art. Further, for purposes of this specification, the term “playback” should be understood to be synonymous with “viewing,” and a “playback device” should be understood to be a device that allows “viewing” of multimedia objects.

While this invention has been described with reference to illustrative embodiments, this description should not be construed in a limiting sense. Various modifications of the described embodiments, as well as other embodiments of the invention, which are apparent to persons skilled in the art to which the invention pertains are deemed to lie within the principle and scope of the invention as expressed in the following claims.

Although the steps in the following method claims are recited in a particular sequence, unless the claim recitations otherwise imply a particular sequence for implementing some or all of those steps, those steps are not necessarily intended to be limited to being implemented in that particular sequence.

What is claimed is:

1. A computer-implemented method for distributing multimedia objects, the method comprising the steps of:
receiving a first request for a multimedia object via a first playback device; and
determining object-viewing rights for the multimedia object with respect to the first playback device, wherein, if the object-viewing rights allow viewing, then:
determining format capabilities of the first playback device; and
distributing a first portion of the multimedia object to the first playback device in a first format that is compatible with the format capabilities of the first playback device.

2. The invention of claim 1, wherein the request includes a device-unique identifier, and determining the object-viewing rights includes:
using the device-unique identifier to determine an owner of the first playback device; and
determining the object-viewing rights for the multimedia object as a function of the owner's object-viewing rights.

3. The invention of claim 1, wherein:
the request includes a device-unique identifier that is used to determine the user of the playback device and thereby the user's viewing preferences; and
distributing the first portion of the multimedia object includes using the user's viewing preferences to affect the playback of the first portion of the multimedia object by the first playback device.

4. The invention of claim 1, further comprising:
receiving a second request for the multimedia object via a second playback device; and
determining object-viewing rights for the multimedia object with respect to the second playback device, wherein, if the object-viewing rights allow viewing, then:
determining format capabilities of the second playback device; and
distributing a second portion of the multimedia object to the second playback device in a second format that is compatible with the format capabilities of the second playback device, wherein the second format is different from the first format.

5. The invention of claim 4, wherein distributing the second portion of the multimedia object includes retrieving data indicating substantially where the first portion of the multimedia object ends and using the data to determine substantially the beginning of the second portion of the multimedia object.

6. The invention of claim 1, wherein determining the object-viewing rights includes authenticating the first playback device.

7. The invention of claim 1, wherein determining the object-viewing rights includes:
determining the user of the first playback device; and
determining the object-viewing rights for the multimedia object as a function of the user's relationship to an owner of the multimedia object.

8. The invention of claim 7, wherein determining the user of the first playback device includes authenticating the user.

9. The invention of claim 1, wherein determining the object-viewing rights includes determining parental control settings of the first playback device with respect to a content rating of the multimedia object.

10. The invention of claim 1, wherein the first request conveys a transport requirement of the first playback device and distributing the first portion of the multimedia object includes packaging the multimedia object in a transport layer compatible with the transport requirement of the first playback device.

11. The invention of claim 1, wherein the first request includes a device-unique identifier for the first playback device and distributing the first portion of the multimedia object includes wrapping the multimedia object in a presentation layer that is specific to capabilities of the first playback device.

12. A system for managing distribution of multimedia objects, the system comprising an application server, the application server adapted to:
receive a first request for a multimedia object from a first playback device; and
determine object-viewing rights for the multimedia object with respect to the first playback device, wherein, if the object-viewing rights allow viewing, then the application server:
determines format capabilities of the first playback device;
supports distribution of a first portion of the multimedia object to the first playback device in a first format that is compatible with the format capabilities of the first playback device.

13. The invention of claim 12, further comprising a user-profile database communicatively coupled to the application server, wherein the first request includes a device-unique identifier for the first playback device, and determining the object-viewing rights includes using the device-unique identifier as a parameter in a query to the user-profile database to determine the object-viewing rights, with respect to the first playback device, as a function of viewing rights for the multimedia object that are held by an owner of the first playback device.

14. The invention of claim 12, further comprising a user-profile database communicatively coupled to the application server, wherein:
the first request includes a device-unique identifier for the first playback device that is used as a parameter in a query to the user-profile database to determine the user of the playback device and thereby the user's viewing preferences; and
to support the distribution of the first portion of the multimedia object, the application server is adapted to use the user's viewing preferences to affect the playback of the first portion of the multimedia object by the first playback device.

15. The invention of claim 12, wherein the application server is adapted to:
receive a second request for the multimedia object from a second playback device; and
determine object-viewing rights for the multimedia object with respect to the second playback device, wherein, if the object-viewing rights allow viewing, then the application server:
determines format capabilities of the second playback device; and
supports distribution of a second portion of the multimedia object to the second playback device in a second format that is compatible with the format capabilities of the second playback device, wherein the second format is different from the first format.

16. The invention of claim 15, comprising a user-profile database communicatively coupled to the application server, wherein, to support the distribution of the second portion of the multimedia object, the application server is adapted to retrieve data from the user-profile database, the data indicating substantially the end of the first portion of the multimedia object and substantially the beginning of the second portion of the multimedia object.

17. The invention of claim 12, comprising a format transcoder communicatively coupled to the application server and operatively coupled between a multimedia-object server and the first playback device, wherein:
the multimedia-object server is adapted to store the multimedia object in a stored format; and
to support the distribution of the first portion of the multimedia object, the application server is adapted to instruct the format transcoder to transcode the multimedia object from the stored format to a format that is different from the stored format.

18. The invention of claim 12, comprising an authentication server communicatively coupled to the application server, wherein the first request includes device-authenticating data for the first playback device and determining the object-viewing rights includes using the device-authenticating data in a communication with the authentication server to authenticate the first playback device.

19. The invention of claim 18, wherein that application server is adapted to receive user-authenticating data via the first playback device, for a user of the first playback device, and determining the object-viewing rights of the first playback device includes using the user-authenticating data in a communication with the authentication server to authenticate the user of the first playback device.

20. The invention of claim 12, comprising a user-profile database communicatively coupled to the application server, wherein the first request includes a device-unique identifier for the first playback device and an object-unique identifier for the multimedia object that are used as parameters in one or more queries to the user-profile database to determine the object-viewing rights as a function of the user's relationship to an owner of the multimedia object.

21. The invention of claim 12, comprising an encryptor communicatively coupled to the application server and operatively coupled between a multimedia object server and the first playback device, wherein to support the distribution of the first portion of the multimedia object, the application server is adapted to instruct the encryptor to encrypt the first portion of multimedia object.

22. The invention of claim 12, comprising a transport converter communicatively coupled to the application server and operatively coupled between a multimedia object server and the first playback device, wherein the first request conveys a transport requirement of the first playback device and, to support the distribution of the first portion of the multimedia object, the application server is adapted to instruct the transport converter to package the multimedia object in a transport layer compatible with the transport requirement of the first playback device.

23. A multimedia-object server communicatively coupled to a first playback device through a network, the multimedia-object server adapted to:
receive a first request for a multimedia object from the first playback device; and
determine object-viewing rights for the multimedia object with respect to the first playback device, wherein, if the object-viewing rights allow viewing, then the multimedia-object server:
determines format capabilities of the first playback device; and
supports the distribution of a first portion of the multimedia object to the first playback device in a first format that is compatible with the format capabilities of the first playback device.
